(19) United States
(12) Patent Application Publication
(10) Pub. No.: US 2012/0034471 A1
(43) Pub. Date: Feb. 9, 2012

(54) THERMAL BARRIER SYSTEMS INCLUDING YTTRIUM GRADIENT LAYERS AND METHODS FOR THE FORMATION THEREOF

(75) Inventor: Benjamin Howard Peterson, Mesa, AZ (US)

(73) Assignee: HONEYWELL INTERNATIONAL INC., Morristown, NJ (US)

(21) Appl. No.: 12/853,060

(22) Filed: Aug. 9, 2010

(51) Int. Cl. B32B 5/14; H05H 1/24; B32B 15/00

(52) U.S. Cl. 428/457; 428/610; 427/576

(57) ABSTRACT

Embodiments of a thermal barrier system are provided, as are embodiments of a method for forming such a thermal barrier system over a gas turbine engine component. In one embodiment, the thermal barrier system includes a bond coat formed over a surface of a gas turbine engine component, and an yttrium-stabilized zirconia thermal barrier coating formed over the bond coat. The yttrium-stabilized zirconia thermal barrier coating includes an yttrium gradient layer having an yttrium content that increases with increasing distance from the bond coat.

### TECHNICAL FIELD

The following disclosure relates generally to thermal barrier systems and, more particularly, to embodiments of a thermal barrier system including an yttrium gradient layer, as well as to methods for the formation of such a thermal barrier system.

### BACKGROUND

Thermal barrier systems are commonly formed over heat-exposed surfaces of combustor cans, heat shields, turbine blades, nozzle guide vanes, duct members, and other such components included within modern gas turbine engines (commonly referred to as “hot section components”). During engine operation, a thermal barrier system thermally isolates the hot section component, and specifically the underlying superalloy from which the hot section component is typically fabricated, from high temperature combustive gas flow. In addition, thermal barrier systems reduce structural degradation of the hot section component due to hot gas corrosion, oxidation, erosion, and the like. Thermal barrier systems thus enable gas turbine engines to operate at a higher core temperatures, and therefore at greater efficiencies, for longer periods of time and over longer operational lifespans.

A thermal barrier system typically includes a bond coat, which is formed over the heat-exposed surface of the hot section component, and at least one thermal barrier coating (also commonly referred to as a “TBC” or “top coat”), which is formed over the bond coat. The thermal barrier coating, in turn, often includes at least one ceramic layer formed primarily from zirconia (ZrO₂). In many cases, one or more secondary oxides are added to the zirconia-based ceramic coating to improve coating stability. Although other stabilizing oxides have been utilized (e.g., hafnium), and other weight percentages have been employed, zirconia-based coating containing approximately 7% to 8% yttrium (Y₂O₃), by weight (commonly referred to as “7-8YSZ coatings”), have emerged as the predominate thermal barrier coating composition utilized by the majority of manufacturers and suppliers within the aerospace industry. The widespread usage of 7-8YSZ coatings is due, at least in part, to the excellent machinabillity, fracture toughness, and adherence to metallic bond coats provided by such coatings.

While providing the above-noted advantages, 7-8YSZ coatings are generally limited to maximum operational temperatures near 1260° C. When a 7-8YSZ coating is exposed to temperatures exceeding this upper threshold, the coating undergoes a phase change (in particular, the coating's crystalline structure changes from a meta-stable tetragonal to cubic at elevated temperatures and then to monoclinic upon cooling) and the volume of the coating increases. Although the coating's volumetric increase may be relatively minor (e.g., approximately 3%), the ceramic coating is typically unable to accommodate even a modest volumetric increase due to its inherent rigidity. As a result, 7-8YSZ coating continually exposed to temperatures exceeding 1260° C. tend to erode, possibly buckle and separate along the barrier coating-bond coat interface (commonly referred to as “spallation”), and ultimately flake away leaving the hot section component unprotected. As a further limitation, conventionally-employed 7-8YSZ coatings are prone to sintering during elevated temperature exposure. That is, when exposed to elevated temperatures, the particles within a given 7-8YSZ coating tend to adhere one another, which reduces the coating's porosity and creates tensile strain in the coating caused by the associated shrinkage. As the coating's porosity is reduced, the coating's thermal conductivity is increased and the ability to accommodate strain is reduced. The overall effectiveness of the 7-8 YSZ coating as a thermal barrier is consequently diminished.

Considering the above, it is desirable to provide embodiments of a thermal barrier systems that provides the benefits of conventionally-employed 7-8YSZ thermal barrier coatings, while also providing improved phase stabilities at higher operating temperatures (e.g., operational temperatures exceeding approximately 1260° C.) and improved sintering resistances. It would also be desirable to provide methods for forming such a thermal barrier coating over a gas turbine engine component. Other desirable features and characteristics of the present invention will become apparent from the subsequent Detailed Description and the appended Claims, taken in conjunction with the accompanying Drawings and this Background.

### BRIEF SUMMARY

Embodiments of a thermal barrier system are provided for formation over a gas turbine engine component. In one embodiment, the thermal barrier system includes a bond coat formed over a surface of a gas turbine engine component, and an yttrium-stabilized zirconia thermal barrier coating formed over the bond coat. The yttrium-stabilized zirconia thermal barrier coating includes an yttrium gradient layer having an yttrium content that increases gradually with increasing distance from the bond coat.

Embodiments of a method are further provided for forming a thermal barrier system over a gas turbine engine component. In one embodiment, the method comprises the step of continually depositing yttrium-stabilized zirconia over a surface of the gas turbine engine component while increasing the yttrium content thereof to form an yttrium-stabilized zirconia thermal barrier coating comprising an yttrium gradient layer.

### BRIEF DESCRIPTION OF THE DRAWINGS

At least one example of the present invention will hereinafter be described in conjunction with the following figures, wherein like numerals denote like elements, and:

FIG. 1 is a cross-sectional view of a thermal barrier system formed over a generalized gas turbine engine component in accordance with an exemplary embodiment;

FIG. 2 is a flowchart illustrating an exemplary method suitable for forming the thermal barrier system shown in FIG. 1;

FIG. 3 is a generalized diagram of a plasma spray apparatus that can be utilized to form the yttrium gradient layer included within the thermal barrier system shown in FIG. 1 in accordance with one possible implementation of the exemplary method shown in FIG. 2; and

FIG. 4 is a graph of spray powder composition (vertical axis) versus time (horizontal axis) illustrating one manner in which the feed ratio of two different powder feedstocks may be varied over time to yield the yttrium gradient layer included within the thermal barrier system shown in FIG. 1.

### DETAILED DESCRIPTION

The following Detailed Description is merely exemplary in nature and is not intended to limit the invention or the application and uses of the invention. Furthermore, there is no intention to be bound by any theory presented in the preceding Background or the following Detailed Description. As appearing herein, the term “over” is utilized to denote the relative positioning of layers and other structural elements (e.g., gas turbine engine components) and does not necessarily denote direct contact between the specified layers or structural elements, unless otherwise stated.

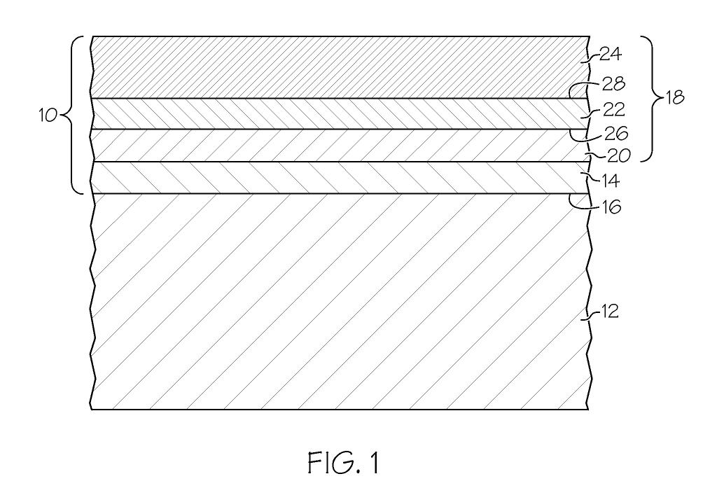

FIG. 1 is a cross-sectional view of a thermal barrier system 10 and a generalized gas turbine engine (“GTE”) component 12 in accordance with an exemplary embodiment. Thermal barrier system 10 includes a metallic bond coat 14 and a ceramic thermal barrier coating 18 (“TBC 18”). TBC 18 is formed over bond coat 14, which is, in turn, formed over at least one surface 16 of GTE component 12. In the illustrated example, TBC 18 includes three layers: a first yttrium-stabilized zirconia (“YSZ”) layer 20, an yttrium gradient layer 22, and a second YSZ layer 24. The layers of thermal barrier coating 18 are successively deposited over bond coat 14 such that second YSZ layer 20 overlies yttrium gradient layer 22, yttrium gradient layer 22 overlies first YSZ layer 20, and first YSZ layer 20 overlies bond coat 14. In view of their relative proximity to GTE component 12, first YSZ layer 20 and second YSZ layer 24 are referred to herein as “inner YSZ layer 20” and “outer YSZ layer 24,” respectively. It will be recognized, however, that thermal barrier system 10 may be formed over an inner surface of GTE component 12 and, further, that component 12 may be mounted within a gas turbine engine in any orientation in three dimensional space. Consequently, in certain embodiments, outer YSZ layer 24 may reside closer to the longitudinal axis of GTE component 12 and/or closer to the longitudinal axis of the host gas turbine engine than does inner YSZ layer 20.

GTE component 12 may comprise any structural element or assemblage of structural elements included within a gas turbine engine and subjected to elevated temperatures during engine operation. In many cases, GTE component 12 will assume the form of a component included within the gas turbine engine's combustor section or turbine section and having at least one surface exposed to hot gas flow produced by combustion of a fuel-air mixture. To list but a few examples, GTE component 12 may assume the form of a combustor can, a heat shield, a turbine shroud, a turbine blade, a nozzle guide vane, or a duct member. GTE component 12 is conveniently, although not necessarily, formed from a nickel- or cobalt-based superalloy, such as Inconel®.

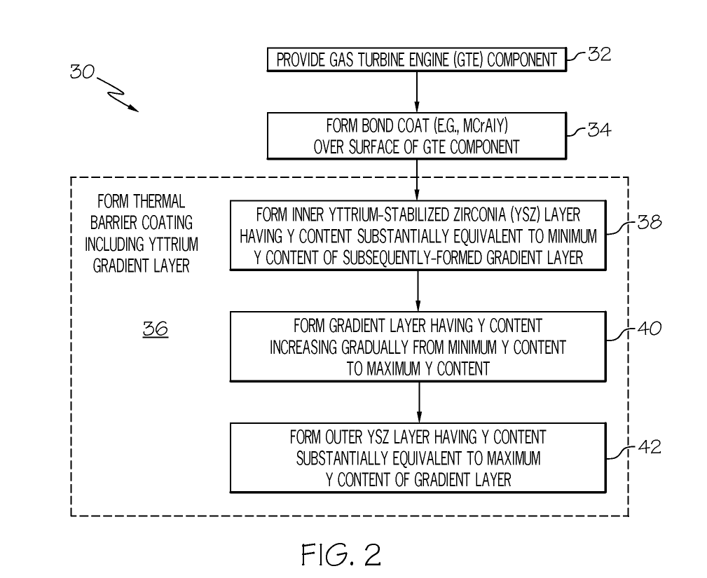

Bond coat 14 may comprise any metallic material, whether currently known or later developed, suitable for bonding TBC 18 to GTE component 12. In one embodiment, bond coat 14 is an aluminide-based alloy. In a second, preferred embodiment, bond coat 14 is a MCrAlY-based alloy, wherein M represents nickel, cobalt, or a nickel-cobalt alloy; and wherein Cr, Al, and Y represent chromium, aluminum, and yttrium, respectively. A given bond coat alloy can, and typically will, include lesser amounts of one or more additional metallic or non-metallic constituents, which may be added in powder form to a master alloy during processing to optimize the metallurgical properties of the resulting alloy. For example, small amounts of nickel, cobalt, hafnium, tantalum, zirconium, and the like may be added to a MCrAlY-based bond coat to optimize, for example, the bond coat's oxidative resistance. Bond coat 14 may be formed utilizing any one of a number of conventionally-known deposition processes, such as the processes set-forth below in conjunction with FIG. 2.

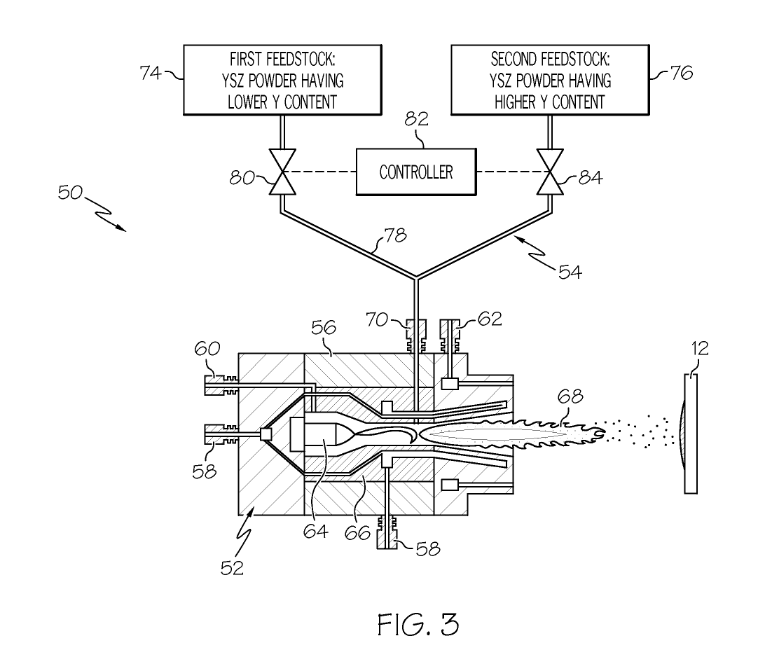

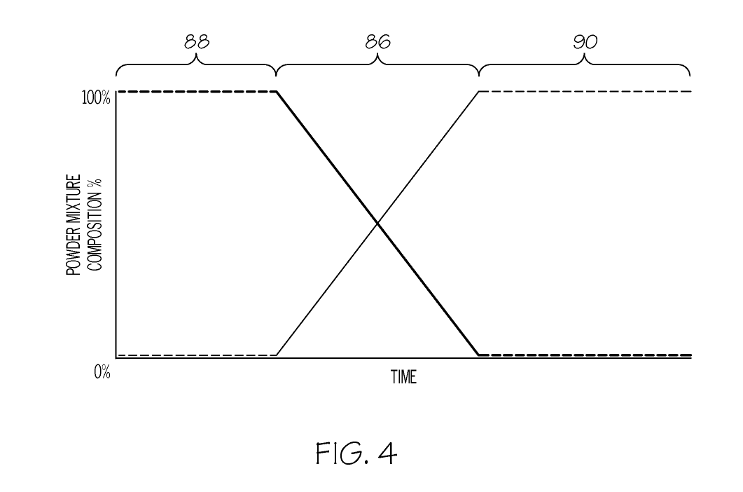

Inner YSZ layer 20, yttrium gradient layer 22, and outer YSZ layer 24 may be formed as an integral structure utilizing a single, continually-performed process. Alternatively, layers 20, 22, and 24 may be formed discrete layers utilizing a series of sequentially performed fabrication steps. In this latter case, layers 20, 22, and 24 may be formed utilizing the same type of process or, instead, utilizing two or more different types of processes. In either case, yttrium gradient layer 22 is formed as a single, unitary layer utilizing a continual, uninterrupted deposition process, such as an electron beam physical vapor deposition (“EB-PVD”) process or the plasma spray process described below in conjunction with FIGS. 3 and 4.

As a point of emphasis, the yttrium content of yttrium gradient layer 22 increases with increasing distance from bond coat 14. In a preferred embodiment wherein yttrium gradient layer 22 includes an inner surface 26 and an outer surface 28 (again, defined in view of their proximity to GTE component 12), yttrium gradient layer 22 has a minimum yttrium content adjacent inner surface 26, has a maximum yttrium content adjacent outer surface 28, and transitions from the minimum yttrium content to the maximum yttrium content when moving from inner surface 26 to outer surface 28. The yttrium content of yttrium gradient layer 22 preferably increases in a gradual or progressive manner through the full thickness of layer 22. In general, it is desirable to impart yttrium gradient layer 22 with a gradient profile that is substantially linear or exponential, as taken through the thickness of layer 22; however, due to practical limitations that may be inherent in the process utilized to form yttrium gradient layer 22, such as the plasma spray process described below, it may be impossible or impractical to impart layer 22 with an infinitely smooth gradient profile. Thus, in many cases, the yttrium profile of layer 22 may comprise a series of incremental steps or gains in yttrium content, which collectively approximate a line or curve.

In contrast to yttrium gradient layer 22, inner YSZ layer 20 and outer YSZ layer 24 each have a substantially uniform yttrium content through their respective thicknesses, with outer YSZ layer 24 having an yttrium content exceeding that of inner YSZ layer 20. In embodiments wherein no intervening layers are formed between inner YSZ layer 20 and yttrium gradient layer 22, and therefore inner surface 26 of yttrium gradient layer 22 is bonded directly to YSZ layer 20, it is preferred that the yttrium content of inner YSZ layer 20 is substantially equivalent to the minimum yttrium content of yttrium gradient layer 22. In this manner, the yttrium content across the interface of inner YSZ layer 20 and yttrium gradient layer 22 may be held substantially constant to promote durable interlayer bonding. Similarly, in embodiments wherein no intervening layers are formed between outer YSZ layer 24 and yttrium gradient layer 22, and therefore outer surface 28 of yttrium gradient layer 22 is bonded directly to YSZ layer 24, it is preferred that the yttrium content of outer YSZ layer 20 is substantially equivalent to the maximum yttrium content of yttrium gradient layer 22 to again promote durable interlayer bonding and optimize the structural integrity of the resulting thermal barrier coating.

The minimum and maximum yttrium contents of yttrium gradient layer 22 will inevitably vary amongst different embodiments of thermal barrier system 10. However, in a preferred embodiment, the minimum yttrium content of yttrium gradient layer 22 is approximately 7% to approximately 8%, by weight of yttrium (“7-8YSZ”). Yttrium gradient layer 22 is preferably formed to have a minimum yttrium content of approximately 7-8% for multiple reasons. First, as noted in the foregoing section entitled “Background,” 7-8YSZ material is readily available within the aerospace industry, is highly machinable, and demonstrates excellent fracture toughness when deployed within a gas turbine engine environment. In addition, 7-8YSZ adheres well to MCrAlY-based bond coats. Durable bonding between bond coat 14 and inner YSZ layer 20 can thus be promoted by forming yttrium gradient layer 22 to have a minimum yttrium content of approximately 7-8% in preferred embodiments wherein bond coat 14 is formed from a MCrAlY-based alloy and the yttrium content of inner YSZ layer 20 is substantially equivalent to the minimum yttrium content of yttrium gradient layer 22.

The maximum yttrium content of yttrium gradient layer 22 is preferably greater than approximately 12%, by weight of yttrium; more preferably, between approximately 15% and approximately 65%, by weight of yttrium; and, still more preferably, approximately 20%, by weight of yttrium. In many cases, the maximum yttrium content of yttrium gradient layer 22 will be at least twice the minimum content of layer 22. Forming yttrium gradient layer 22 as a compositional gradient structure that transitions from a first yttrium content (e.g., 7-8%, by weight of yttrium) to a second, significantly higher yttrium content (e.g., 20%, by weight of yttrium) provides at least two advantages. First, as the yttrium content of yttrium gradient layer 22 increases, so too does the overall phase stability of layer 22. Thus, relative to a comparable YSZ layer having a lower yttrium content (e.g., a uniform YSZ layer having an yttrium content of 7-8%), yttrium gradient layer 22 can be subjected to higher temperatures without undergoing a phase change and a corresponding expansion in volume. Yttrium gradient layer 22, and more generally TBC 18, can consequently be subjected to higher combustive gas temperatures (e.g., temperatures exceeding 1260° C.) without experiencing a phase transformation otherwise causing the thermal barrier coating to degrade, as previously described. As a second advantage, by forming yttrium gradient layer 22 to gradually increase from a minimum to a maximum yttrium content, the overall sintering resistance of TBC 18 is significantly improved. Such an increase in sintering resistance allows yttrium gradient layer 22, as well as outer YSZ layer 24, to maintain a higher porosity through elevated temperature exposure. This, in turn, allows the thermal conductivity of TBC 18 to be maintained at low levels and thermal expansion and contraction strains to be accommodated through elevated temperature exposure thereby maintaining the overall effectiveness of TBC 18 as a thermal barrier.

Notably, the above-described advantages provided by yttrium gradient layer 22, in combination with inner YSZ layer 20 and outer YSZ layer 24, cannot be achieved by simply depositing an yttrium-stabilized zirconia layer having a higher yttrium content directly over bond coat 14; it has been found that YSZ layers having higher yttrium contents (e.g., yttrium contents approaching or exceeding 20%) tend to bond poorly with conventionally-employed bond coat materials. Furthermore, YSZ coatings having yttrium contents around 20%, by weight of yttrium, tend to form detrimental phases with MCrAlY bond coat alloys and are consequently incompatible therewith. Nor can the above-described advantages be achieved by simply depositing an yttrium-stabilized zirconia layer having a higher yttrium content (e.g., 20%, by weight of yttrium) over an yttrium-stabilized zirconia layer having a lower yttrium content (e.g., 7-8%, by weight of yttrium); such dual-layer combinations likewise tend to bond poorly and, therefore, are prone to separation over repeated thermal cycles within a gas turbine engine environment. In contrast, by forming a composition gradient structure that gradually transitions from a lower yttrium content to a higher yttrium content in the above-described manner, a thermal barrier coating can be produced that achieves the above-noted advantages, while also demonstrating superior structural durability within high temperature GTE environments.

FIG. 2 is a flowchart illustrating an exemplary method 30 that may be performed to form a thermal barrier system including an yttrium gradient layer of the type described above. For ease of explanation, exemplary method 30 is described below in conjunction with thermal barrier system 10 shown in FIG. 1; it is noted, however, that exemplary method 30 can be utilized to form thermal barrier systems that differ materially from thermal barrier system 10. Referring jointly to FIGS. 1 and 2, method 30 commences with the provision of a gas turbine engine component, such as GTE component 12 (STEP 32, FIG. 2). As explained above, GTE component 12 can comprises any type of structural element included within a gas turbine engine and heated during operation thereof. As also noted above, GTE component 12 is conveniently fabricated (e.g., cast) from a nickel- or cobalt-based superalloy, such as Inconel®. If desired, one or more surfaces of GTE component 12 (e.g., surface 16 identified in FIG. 1) may be cleaned (e.g., with a degreasing agent), planarized (e.g., via lapping, grinding, or chemical-mechanical planarization), and/or otherwise prepared for the subsequent formation of bond coat 14 during STEP 32 (FIG. 2).

Next, during STEP 34 (FIG. 2), bond coat 14 is formed over surface 16 of GTE component 12 (FIG. 1). As noted above, in a preferred embodiment, bond coat 14 is formed via deposition of a MCrAly-based alloy. Any one of a number of conventionally-known deposition techniques can be utilized to form bond coat 14 over GTE component 12. Processes suitable forming bond coat 14 include, but are not limited to, physical vapor deposition, cladding, high velocity oxygen fuel spraying, low pressure plasma spraying, vacuum plasma spraying, and air plasma spraying. As a non-limiting example, bond coat 14 may be deposited to a thickness of approximately 0.012 millimeter to approximately 0.254 millimeter.

Exemplary method 30 continues with the formation of TBC 18 over bond coat 14. As indicated in FIG. 2 at 36, at least three steps may be performed to produce the successive layers of TBC 18. First, at STEP 38 (FIG. 2), inner yttrium-stabilized zirconia layer 20 is deposited over bond coat 14 (FIG. 1). Next, at STEP 40 (FIG. 2). yttrium gradient layer 22 is deposited over inner yttrium-stabilized zirconia layer 20 (FIG. 1). Finally, at STEP 42 (FIG. 2), outer yttrium-stabilized zirconia layer 24 is deposited over yttrium gradient layer 22 (FIG. 1). In certain embodiments of method 30, STEPS 38, 40, and 42 may be performed in a continual manner. That is, the process utilized to form inner YSZ layer 20 may be continued, without interruption, to form yttrium gradient layer 22; and/or the process utilized to form yttrium gradient layer 22 may be continued, without interruption, to form outer YSZ layer 24. Such a continuous process yields an integrally-formed thermal barrier coating having exceptional structural integrity. This notwithstanding, STEPS 38, 40, and 42 may be performed in a non-continuous or intermittent manner in further embodiments. In such embodiments, layers 20, 22, and 24 will comprise discrete, separately-formed structures; however, durable bonding between neighboring layers 20, 22, and 24 can still be achieved, especially in embodiments wherein the yttrium contents of YSZ layers 20 and 24 are substantially equivalent to the minimum and maximum yttrium contents of yttrium gradient layer 22, respectively. In embodiments wherein STEPS 38, 40, and 42 are discretely performed, different techniques may be utilized to form each of layers 20, 22, and 24; e.g., layers 20 and 24 may be formed utilizing a conventional deposition technique, such as a conventional plasma spray technique or an EB-PVD technique, while yttrium gradient layer 22 may be formed utilizing a modified plasma spray technique of the type described below. By way of non-limiting example, inner YSZ layer 20 may be deposited to a thickness between approximately 0.025 millimeter and approximately 2.0 millimeters; yttrium gradient layer 22 may be deposited to a thickness of approximately 0.127 millimeter to approximately 2.0 millimeters; and outer YSZ layer 24 may be deposited to a thickness between approximately 0.025 millimeter and approximately 0.75 millimeter. The foregoing notwithstanding, it will be appreciated that the thicknesses of inner YSZ layer 20, yttrium gradient 22, and outer YSZ layer 24 will vary, at least in part, based upon the selected deposition process and desired microstructure; e.g., whether layers 20, 22, and 24 are formed utilizing EB-PVD, plasma spray, or another suitable process and are formed to have a low density (porous) microstructure, a vertically cracked microstructure, or another microstructure.

FIG. 3 is a generalized schematic of a plasma spray apparatus 50 that may employed to produce yttrium gradient layer 22, and potentially also YSZ layers 20 and 24, in an exemplary implementation of method 30. As can be seen in FIG. 3, plasma spray apparatus 50 includes a plasma spray gun 52 and a multi-feedstock powder supply system 54, which supplies plasma spray gun 52 with a powder mixture in the manner described below. Plasma spray gun 52 includes a spray gun housing 56; liquid inlet and outlet ports 58, which can be connected to a pump (not shown) to circulate a liquid coolant (e.g., water) through spray gun housing 56; a gas inlet port 60, which can be connected to a plasma source (not shown) to supply plasma spray gun 52 with a combustible plasma; and a gas outlet port 62, which can be used for a carrier and/or plasma shrouding gas during bond coat and/or top coat deposition. Plasma spray gun 52 also includes first and second electrodes 64 and 66, which are energized during operation of plasma spray gun 52 to create an electrical arc to create the plasma and produce a flame 68. Lastly, at least one powder feed port 70 couples plasma spray gun 52 to powder supply system 54. During operation of plasma spray gun 52, powder feed port 70 directs a powder mixture received from powder supply system 54 into flame 68, which rapidly melts the powder mixture particles and propels the particles from the nozzle of gun 52 and against GTE component 12. As they impinge upon the surface of GTE component 12 (or, more accurately, on bond coat 14), the particles gradually produce a dense, adhesive ceramic coating having the above-described properties. In embodiments wherein it is desired to impart TBC 18 with a porous, low density microstructure, process parameters can be controlled to cause the impinging particles to deform or flatten into numerous lamellae or plate-like formations commonly referred to as “splats” and provide a controlled porosity. Alternatively, in embodiments wherein it is desired to impart TBC 18 with a vertically cracked microstructure, a similar but modified process may be employed wherein GTE component 12 is heated in a controlled manner to induce vertically-propagated cracks during coating deposition.

With continued reference to FIG. 3, powder supply system 54 includes a first powder feedstock 74, a second powder feedstock 76, and a bifurcated flow passage 78, which couples powder feedstocks 74 and 76 to powder feed port 70 of plasma spray gun 52. A first flow control valve 80 is positioned across a first leg of bifurcated flow passage 78 downstream of powder feedstock 74; and a second flow control valve 84 is positioned across a second, opposing leg of bifurcated flow passage 78 downstream of powder feedstock 76. A controller 82 is operably coupled to flow control valves 80 and 84 and, during the plasma spray process, adjusts the position of valves 80 and 84 to control the rate of powder flowing from feedstocks 74 and 76 to plasma spray gun 52 and, therefore, the overall composition of the powder mixture supplied to plasma spray gun 52. In one embodiment, controller 82 adjusts the position of valves 80 and 84 in accordance with a predetermined flow schedule, such as that described below in conjunction with FIG. 4.

The yttrium content of powder feedstock 74 is less than the yttrium content of powder feedstock 76. In a preferred embodiment, the yttrium content of powder feedstock 74 is substantially equivalent to the desired minimum yttrium content of yttrium gradient layer 22; and the yttrium content of powder feedstock 76 is substantially equivalent to the desired maximum yttrium content of yttrium gradient layer 22. In this manner, a relatively straightforward plasma spray process can be performed wherein the powder mixture supplied to plasma spray gun 52 gradually transitions from an initial composition comprising substantially 100% powder drawn from feedstock 74 and substantially 0% powder drawn from feedstock 76 to a final composition comprising substantially 0% powder drawn from feedstock 74 and substantially 100% powder drawn from feedstock 76. Further emphasizing this point, FIG. 4 is a graph of spray powder composition (vertical axis) versus time (horizontal axis) illustrating one manner in which controller 82 may adjust ratio of the powder mixture drawn from feedstock 74 and 76 during the thermal spray process. As indicated in FIG. 4 at 86, controller 82 may modulate flow control valves 80 and 82 (i.e., gradually open valve 80 while gradually closing valve 82) to progressively change the powder mixture composition from a low yttrium content powder mixture composed substantially entirely of powder drawn from feedstock 74 to a high yttrium content powder mixture composed substantially entirely of powder drawn from feedstock 76 over the time period during which yttrium gradient layer 22 is formed. Yttrium gradient layer 22 is thus formed to have a minimum yttrium content substantially equivalent to the yttrium content of feedstock 74 adjacent inner surface 26 (FIG. 1), to have a maximum yttrium content substantially equivalent to the yttrium content of feedstock 76 adjacent outer surface 28 (FIG. 1), and to gradually transition from the minimum yttrium content to the maximum yttrium content when moving from inner surface 26 to outer surface 28 (FIG. 1).

In embodiments wherein inner YSZ layer 20 is integrally formed with yttrium gradient layer 22, the plasma spray process may commence prior to formation of layer 22. In particular, as indicated in FIG. 4 at 88, inner YSZ layer 20 may first be formed by plasma spraying a powder mixture over bond coat 14 (FIG. 1) while drawing substantially 100% powder from feedstock 74 (flow control valve 80 fully open) and substantially 0% powder from feedstock 76 (flow control valve 82 fully closed). In this manner, inner YSZ layer 20 is formed to have an yttrium content substantially equivalent to the minimum yttrium content of yttrium gradient layer 22. After formation of inner YSZ layer 20, the plasma spray process may be continued, without interruption, to form yttrium gradient layer 22 in the above-described manner. Similarly, in embodiments wherein outer YSZ layer 24 is integrally formed with yttrium gradient layer 22, the plasma spray process may continue, without interruption, after formation of yttrium gradient layer 22 to further form outer YSZ layer 24. More specifically, as indicated in FIG. 4 at 90, outer YSZ layer 24 may be formed by plasma spraying a powder mixture over yttrium gradient layer 22 while drawing substantially 0% powder from feedstock 74 and substantially 100% powder from feedstock 76. In this manner, outer YSZ layer 24 may be formed to have an yttrium content substantially equivalent to the maximum yttrium content of yttrium gradient layer 22.

During the above-described plasma spray process, various process parameters (e.g., the proximity of spray gun 52 to GTE component 12, powder velocity, powder mixture composition, etc.) to impart inner YSZ layer 20 and outer YSZ layer 24 with desired porosities. In addition, GTE component 12 may be successively heated and cooled during plasma spraying to form vertically-propagated microcracks within inner YSZ layer 20, gradient layer 22, and outer YSZ layer 24. In most cases, the above-described plasma spray process will be performed in an open atmosphere (commonly referred to as “air plasma spraying”); however, the possibility that other types of plasma spray processes (e.g., argon shroud plasma spraying) can be employed is by no means excluded.

Although, in the above-described exemplary embodiment, the yttrium contents of powder feedstocks 74 and 76 are substantially equivalent to the minimum and maximum yttrium contents of yttrium gradient layer 22, respectively, this need not always be the case. If desired, yttrium gradient layer 22 can be formed utilizing powder feedstocks having yttrium contents different than the maximum and minimum yttrium contents of yttrium gradient layer 22, providing that at least one powder feedstock has an yttrium content less than the minimum yttrium content of layer 22 and at least one powder feedstock has an yttrium content greater than the maximum yttrium content of layer 22. If desired, additional powder feedstocks containing one or more additives may also be employed in further embodiments of the above-described plasma spray process.

There has thus been provided multiple exemplary embodiments of a thermal barrier system that achieves the benefits of conventionally-employed 7-8YSZ thermal barrier coatings, while also exhibiting improved phase stabilities at higher operating temperatures (e.g., operational temperatures exceeding approximately 1260° C.) and improved sintering resistances. The foregoing has also provided exemplary embodiments of a method suitable for forming such a thermal barrier coating over a gas turbine engine component. Although preferably formed utilizing a modified plasma spray technique of the type described above, it is emphasized that the yttrium gradient layer (or layers) can be formed utilizing any suitable process, whether currently known or later developed. For example, in certain embodiments, a modified EB-PVD technique can be employed to form yttrium gradient layer wherein the vaporization rate of at least two ingots, each having a different yttrium content, is varied with time to vary the yttrium content of the gasses within the vacuum chamber and, therefore, the composition of the yttrium gradient layer cumulatively deposited over the gas turbine engine component. In one exemplary case, during STEP 40 of exemplary method 30 (FIG. 2), the vaporization rate of a first ingot having an yttrium content substantially equivalent to the gradient layer's desired minimum yttrium content may be gradually decreased from a high level to a low level (e.g., via a continual reduction in electron beam intensity), while the vaporization rate of a second ingot having an yttrium content substantially equivalent to the gradient layer's desired maximum yttrium content is gradually increased from a low level to a high level (e.g., via a continual increase in electron beam intensity), to progressively increase the overall yttrium content of the vacuum chamber atmosphere over the duration of the EB-PVD process to form an yttrium gradient layer of the type described above. In embodiments wherein layer 20 and/or layer 24 are integrally formed with yttrium gradient layer 22 (FIG. 1), the vaporization rate of the first and second ingot may also be controlled, as appropriate, to form inner YSZ layer 20 during STEP 38 of exemplary method 30 (e.g., the vaporization rate of the first ingot may be maintained at a relatively high level, while the vaporization rate of the second ingot is held at or near zero) and/or to form outer YSZ layer 24 during STEP 42 of exemplary method 30 (e.g., the vaporization rate of the second ingot may be maintained at a relatively high level, while the vaporization rate of the first ingot is held at or near zero).

While at least one exemplary embodiment has been presented in the foregoing Detailed Description, it should be appreciated that a vast number of variations exist. It should also be appreciated that the exemplary embodiment or exemplary embodiments are only examples, and are not intended to limit the scope, applicability, or configuration of the invention in any way. Rather, the foregoing Detailed Description will provide those skilled in the art with a convenient road map for implementing an exemplary embodiment of the invention. It being understood that various changes may be made in the function and arrangement of elements described in an exemplary embodiment without departing from the scope of the invention as set-forth in the appended Claims.

What is claimed is:

1. A thermal barrier system for formation over a gas turbine engine component, the thermal barrier system comprising:
a bond coat formed over a surface of the gas turbine engine component; and
an yttrium-stabilized zirconia thermal barrier coating formed over the bond coat and including an yttrium gradient layer having an yttrium content that increases with increasing distance from the bond coat.

2. A thermal barrier system according to claim 1 wherein the yttrium content of the yttrium gradient layer gradually increases from a minimum weight percentage to a maximum weight percentage, taken through the entire thickness of the yttrium gradient layer.

3. A thermal barrier system according to claim 2 wherein the minimum weight percentage is between approximately 7% and approximately 8%, by weight of yttrium.

4. A thermal barrier system according to claim 3 wherein the maximum weight percentage is greater than approximately 12%, by weight of yttrium.

5. A thermal barrier system according to claim 4 wherein the maximum weight percentage is between approximately 15% and approximately 65%, by weight of yttrium.

6. A thermal barrier system according to claim 5 wherein the maximum weight percentage is approximately 20%, by weight of yttrium.

7. A thermal barrier system according to claim 2 wherein the yttrium-stabilized zirconia thermal barrier coating further includes a first yttrium-stabilized zirconia layer formed between the bond coat and the yttrium gradient layer, the first yttrium-stabilized zirconia layer having an yttrium content substantially equivalent to the minimum weight percentage of the yttrium gradient layer.

8. A thermal barrier system according to claim 7 wherein the yttrium-stabilized zirconia thermal barrier coating further includes a second yttrium-stabilized zirconia layer formed over the yttrium gradient layer, the second yttrium-stabilized zirconia layer having an yttrium content substantially equivalent to the maximum weight percentage of the yttrium gradient layer.

9. A thermal barrier system according to claim 8 wherein at least one of the first yttrium-stabilized zirconia layer and the second yttrium-stabilized zirconia layer is integrally formed with the yttrium gradient layer.

10. A thermal barrier system, comprising:
an yttrium gradient layer having a first surface, a second surface substantially opposite the first surface, a minimum yttrium content adjacent the first surface, and a maximum yttrium content adjacent the second surface, the yttrium content of the yttrium gradient layer gradually increasing from the minimum yttrium content to the maximum yttrium content, as taken through the thickness of the yttrium gradient layer;
a first yttrium-stabilized zirconia layer bonded to the first surface and having an yttrium content substantially equivalent to the minimum yttrium content; and
a second yttrium-stabilized zirconia layer bonded to the second surface and having an yttrium content substantially equivalent to the maximum yttrium content.

11. A thermal barrier system according to claim 10 further comprising a MCrAlY-based bond coat over which the first yttrium-stabilized zirconia layer is formed.

12. A thermal barrier system according to claim 10 wherein the minimum weight percentage is between approximately 7% and approximately 8%, by weight of yttrium.

13. A thermal barrier system according to claim 12 wherein the maximum weight percentage is approximately 20%, by weight of yttrium.

14. A thermal barrier system according to claim 10 wherein at least one of the first yttrium-stabilized zirconia layer and the second yttrium-stabilized zirconia layer is integrally formed with the yttrium gradient layer.

15. A method for forming a thermal barrier system over a gas turbine engine component, comprising the step of:
continually depositing yttrium-stabilized zirconia over a surface of the gas turbine engine component while increasing the yttrium content thereof to form an yttrium-stabilized zirconia thermal barrier coating comprising an yttrium gradient layer.

16. A method according to claim 15 wherein the step of continually depositing comprises continually depositing yttrium-stabilized zirconia over a surface of the gas turbine engine component while increasing the yttrium content thereof from a first predetermined weight percentage to a second predetermined weight percentage, the first predetermined weight percentage between approximately 7% and approximately 8%, by weight of yttrium.

17. A method according to claim 16 wherein the second predetermined weight percentage is approximately 20%, by weight of yttrium.

18. A method according to claim 15 wherein the step of continually depositing comprises:
providing a first powder feedstock of yttrium-stabilized zirconia powder having a first predetermined yttrium content;
providing a second powder feedstock of yttrium-stabilized zirconia powder having a second predetermined yttrium content greater than the first predetermined yttrium content; and
forming the yttrium gradient layer by plasma spraying a powder mixture of the first powder feedstock and the second powder feedstock over the gas turbine engine component while gradually decreasing the amount of yttrium-stabilized zirconia powder drawn from the first powder feedstock relative to the amount of yttrium-stabilized zirconia powder drawn from the second powder feedstock.

19. A method according to claim 18 further comprising the steps of:
depositing a bond coat over the gas turbine engine component;
forming an inner yttrium layer over the bond coat by plasma spraying a powder mixture drawn substantially entirely from the first powder feedstock; and
forming an outer yttrium layer over the yttrium gradient layer by plasma spraying a powder mixture drawn substantially entirely from the second powder feedstock.

20. A method according to claim 15 wherein the step of continually depositing comprises:
providing a first ingot comprising yttrium-stabilized zirconia powder having a first predetermined yttrium content;
providing a second ingot comprising yttrium-stabilized zirconia powder having a second predetermined yttrium content greater than the first predetermined yttrium content; and
gradually decreasing the vaporization rate of the first ingot while gradually increasing the vaporization rate of the second ingot to form the yttrium gradient layer over the gas turbine engine component.
